(19) United States
(12) Patent Application Publication
(10) Pub. No.: US 2013/0085928 A1
(43) Pub. Date: Apr. 4, 2013

(54) VEHICLE INTEGRATED PAYMENT DEVICE

(71) Applicant: Timothy McKinney, Old Greenwich, CT (US)

(72) Inventor: Timothy McKinney, Old Greenwich, CT (US)

(73) Assignee: MASTERCARD INTERNATIONAL, INC., Purchase, NY (US)

(21) Appl. No.: 13/252,763

(22) Filed: Oct. 4, 2011

(51) Int. Cl. G06Q 20/10; G06K 19/073; G06K 19/00

(52) U.S. Cl. 705/39; 235/487; 235/492

(57) ABSTRACT

A payment device including a vehicle having a unique identifier associated therewith. The unique identifier is associated with and identifies a specific financial payment account to permit a payment transaction for the purchase of goods and/or services.

### FIELD OF THE INVENTION

The present invention relates to a payment device and more particularly to a payment device having a payment functionality based on a unique identifier of a vehicle.

### BACKGROUND

Electronic payments and other transactions are fast becoming the manner for conducting consumer transactions around the world. Instead of using cash, consumers are using many different types of cards and devices to buy a wide range of items. These consumer transaction devices include, for example, credit cards, debit cards, gift cards, and prepaid cards for such items as gasoline and phone service. Transaction devices are also used to track consumer activities so that incentives may be given to the consumer in the form of a consumer loyalty program. Transaction devices such as credit and debit cards are typically issued by banks or other financial institutions. Retailers of goods and services also issue transaction devices.

Transaction devices may be in the form of a credit or debit card that typically includes magnetic strips which maintain encoded information for authenticating and identifying the user of a card. In addition to a traditional credit card, transaction devices may be in the form of a fob or other device including an embedded RFID chip which contains account information. A card including such an integrated circuit is often referred to as a smart card, chip card or integrated circuit card (ICC).

Transaction devices typically include a unique personal account number (“PAN”) which identifies the account to which the transaction can be assessed. The PAN may be the account number on a credit, debit or charge card. This information may be encoded on the magnetic strip or on a RFID chip in order to permit the transaction device to interact with point of sale (“POS”) devices.

Payment transactions frequently take place in or adjacent to a vehicle. For example, paying for gas, car washes, parking, tolls, vehicle repairs and numerous drive-through services all are conducted from a vehicle and frequently employ payment with a credit or debit card. However, the user must have the payment device present to make the transaction, which is not always the case. Vehicles also are able to receive pay content such as satellite radio. However, to pay for such service a separate account must first be established and the account paid for using a payment device.

In fleet vehicle situations, each driver must be given a payment card to conduct business transactions while using the vehicle. As employees leave and new ones take their place new cards have to be issued. In addition, if cards are lost or stolen new cards need to be issued. Administering this process can be expensive and burdensome for a business.

Accordingly, it would be desirable to have a payment device associated with a vehicle so that the payment device is readily available when making payment transitions in or adjacent to a vehicle.

### SUMMARY

The present invention provides a payment device including a vehicle having a unique identifier associated therewith. The unique identifier is associated with and identifies a specific financial payment account to permit a payment transaction for the purchase of goods and/or services.

The present invention further provides a system for conducting a payment transaction including a vehicle having a Vehicle Identification Number (“VIN”) associated therewith. The VIN forms at least part of a financial payment account number to permit a payment transaction based upon the VIN. A payment apparatus is disposed within the vehicle. The payment apparatus includes a communicating device for selectively transmitting the VIN. The communicating device is in operative communication with a point of sale device to permit transmission of the VIN to the point of sale device, wherein transmission of the VIN in the point of sale device facilitates the payment transaction.

The present invention still further provides a method of establishing functionality of a payment device including:

obtaining a vehicle specific vehicle identification number (“VIN”);

associating the VIN with a particular financial payment account;

storing the association on a payment network; and

selectively facilitating payment transactions based on the VIN.

The present invention still further also provides a method of conducting a payment transaction including providing a vehicle having a unique vehicle identifier associated therewith, the unique identifier being associated with and identifying a specific financial payment account to permit a payment transaction for the purchase of goods and/or services; and

communicating a signal including a unique vehicle identifier to a point of sale device.

### BRIEF DESCRIPTION OF THE DRAWINGS

FIG. 1 is a perspective view of a vehicle including a payment device;

FIG. 2 is a perspective view of a vehicle with integrated payment device wirelessly communicating with a point of sale device;

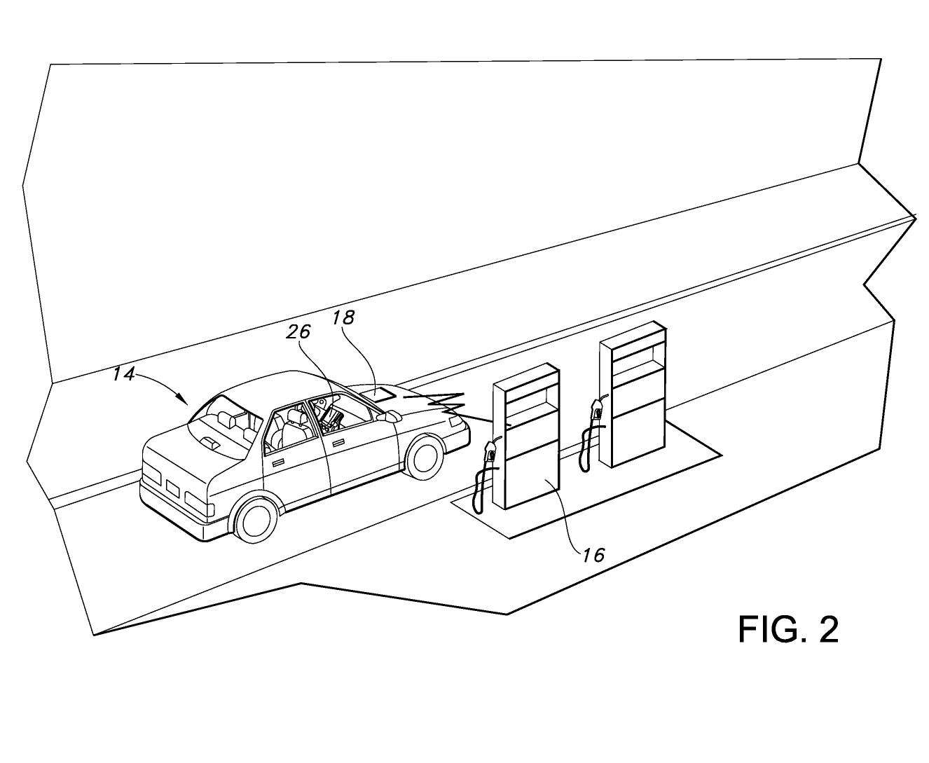

FIG. 3 is a block diagram of a payment apparatus;

FIG. 4 is a schematic view of a user interface of a vehicle based payment apparatus; and

FIG. 5 is a block diagram depicting a payment transaction.

### DETAILED DESCRIPTION

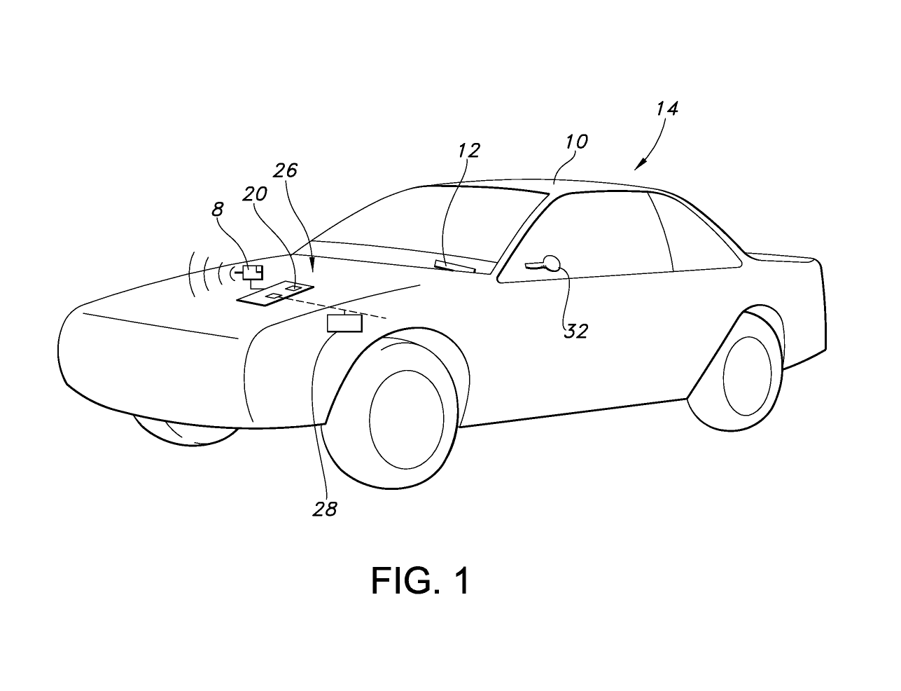

With reference to FIG. 1, the present invention provides a payment functionality which is associated with a vehicle 10. This permits a driver of the vehicle to complete payment transactions using a unique identifier of the vehicle as an account identification number. The vehicle itself acts a payment device. As used herein the term vehicle refers to a self-propelled, boosted, or towed conveyance for transporting a burden on land or sea or through air or space, e.g., car truck, motorcycle, snowmobile, boat, etc.

Each motor vehicle manufactured has its own unique vehicle identification number, VIN. Accordingly, no two vehicles will have such a number. A VIN may consist of an alphanumeric string, for example 1FALP62W4WH128703. The VIN contains such information as the vehicles manufacturer, model, features, model year, location of assembly and production sequence. The number is assigned to the vehicle prior to the vehicle being manufactured and remains with it until the vehicle is scrapped. Accordingly, the VIN is a durable feature of the vehicle which remains with it throughout its life. Other vehicles such as motorcycles, snowmobiles and boats are also assigned unique identification numbers. Such numbers are collectively referred to herein as VIN's or VIN numbers.

In one embodiment of the present invention, the unique identifier is the VIN 12 which is employed by a user to transact payments for goods and services. This is accomplished by associating the VIN with a financial payment account. Accordingly, the VIN identifies a particular payment account. Such association may be created by basing the financial payment account number on the VIN itself. In one embodiment, the financial payment account number corresponds to the VIN. Alternatively, the financial payment account number contains at least a portion of the VIN. The financial payment account may be of a type which may be linked to funds such as a bank deposit account, a credit card account, a prepaid account or the like. Accordingly, the vehicle identification number is a unique identifier which allows access to these funds to permit payment. Accordingly, in the present invention, instead of using a separate card or device and its assigned PAN, the user may use the vehicle identification number to conduct a payment transaction.

By utilizing the VIN as an account number the payment functionality is original equipment on the vehicle. A purchaser does not need to have it added. The payment functionality would travel with the vehicle and is conveyed along with the vehicle to a new owner.

In order for the owner of a vehicle to use the VIN to conduct payment transactions, they may register the VIN with an existing payment network such as that offered by the MasterCard International. The VIN then may be associated with a particular issuing bank which ultimately makes the payments on behalf of the user. The bank may be one in which a user has an existing deposit account. The account may be identified by the vehicle owner and set up after purchase of the vehicle. Alternatively, the account could be setup upon purchase. Consumer incentives could motivate the establishment of a deposit account with a preferred financial institution. With the VIN number registered with and therefore linked to a financial payment account, a vehicle integrated payment device 14 is created. If the vehicle were to be sold to another individual, the new owner could have the VIN associated with a financial institution of their choice.

The VIN may be used to conduct payment transactions in much the same way that a credit or debit card number would be used to perform payment transactions. For example, gas, car washes, parking, tolls, vehicle repairs and drive-through services such as restaurants and pharmacies all can be paid for using the vehicle integrated payment device 14. Additionally, a user may be able to pay for downloadable content to the vehicle such as satellite radio, download audio files or other GPS information or other material to the vehicle. The payment device 14 may also be used to pay car insurance and other car related expenses. Since the user is with the vehicle during these transactions, there is no need to have a separate card, device or other element in order to conduct the payment transaction. The presence of the vehicle alone permits the initiation of the payment transaction.

In order to initiate a payment transaction, the VIN number is preferably communicated to a point of sale device 16. In one embodiment, the vehicle may include a communicating device 18 which wirelessly communicates with a point-of-sale receiver in order to permit transfer of the VIN number. The communicating device 18 may be in the form of an active or passive transmitting device or transceiver capable of sending and receiving information. Additionally, the communicating device 18 may be in the form of an RFID (radio-frequency identification) device that transmits a signal when it receives a request from a monitoring or control point. In one embodiment, when adjacent a point-of-sale device 18 such as on a gas pump, the gas pump may include a transceiver that emits a signal that interrogates the communicating device, which in turn emits a signal corresponding to the VIN number. The VIN number may be transmitted in an encoded form to prevent unauthorized access to the number. Upon receiving the VIN, the information can be processes over a traditional payment network to determine if the purchase is authorized. Once authorization is granted, the user can begin pumping gas. The cost of the gas is then charged to or debited from the account.

It is also within the contemplation of the present invention that the VIN may be stored in a readable format that could be scanned by a point of sale device 16. For example, the VIN could be stored on a magnetic strip or as a bar code. The point of sale device would include the necessary reader to receive the information and relay it to the payment network.

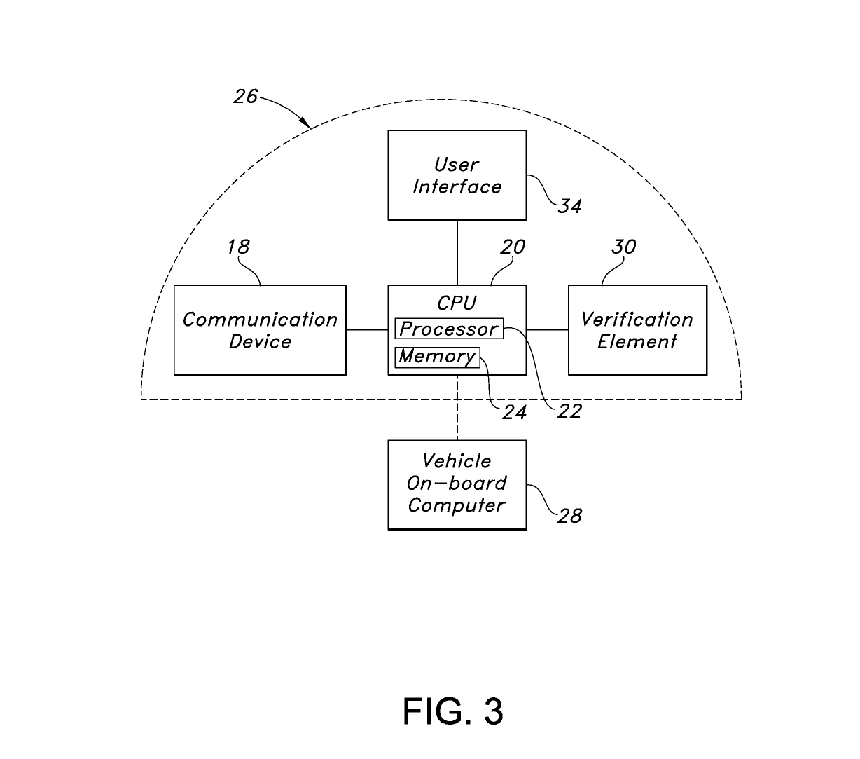

With additional reference to FIG. 3, the vehicle 10 may include a central processing unit, CPU, 20 including a processing device 22 operably connected to memory 24. The CPU 20 may also be operably connected to the communicating device for controlling the transmission of the VIN. The CPU 20 and communicating device together form a payment apparatus 26 located on the vehicle 10. Vehicles typically are manufactured with on-board computers 28. Therefore, it is within the contemplation of the present invention that the payment apparatus CPU 20 may be integrated into an existing vehicle on-board computer 28. In such an embodiment, appropriate programming of such an on-board computer may be provided to a vehicle manufacturer in order to provide the payment functionality of the present invention.

The payment apparatus 26 may be configured such that it transmits the VIN number at appropriate times but also restricts access to the number for security purposes. In order to ensure that the payment transaction is authorized by the user, the payment apparatus 26 may further include a verification element 30. The verification element 30 determines if a verification condition is met, and if not, transmission of the VIN is prevented. The verification condition may be the presence of the vehicle key 32 which is required in order to initiate transmission of the VIN and permit a payment transaction to go forward. Accordingly, unless someone had a vehicle key, they would not be able to use the vehicle as a payment device.

In one embodiment, the user may need to insert the key 32 into the ignition in order for the verification element to provide a signal to the CPU 20 authorizing transmission of the VIN. Alternatively, the key 32 may include a transmitting device which communicates with the vehicle such that the presences of the key within the vehicle may be sensed. The payment apparatus 26 may be operably connected with the vehicle's on-board computer 28. When this computer receives signals that the vehicle key is properly present to initiate ignition, the on-board computer may be configured to send a signal to the payment apparatus 26 to permit transmission of the VIN. In a further alternative embodiment, the verification condition may be the operation of the vehicle including the running of the vehicle's engine.

In addition, it is within the contemplation of the present invention that the vehicle keys 32 may include a computer chip which is programmed for specific users. For example, in a fleet vehicle situation, each driver may have a key of the vehicle, with the key having a chip therein. Accordingly, when they use the vehicle integrated payment device 14 to conduct a payment transaction, the chip may communicate with the payment apparatus 26 such that it can be recorded in the memory 24 which operator made the transaction. The payment apparatus 26 of the vehicle also permits the tracking of the driver's payment activities or locations which is useful for managing fleet operations.

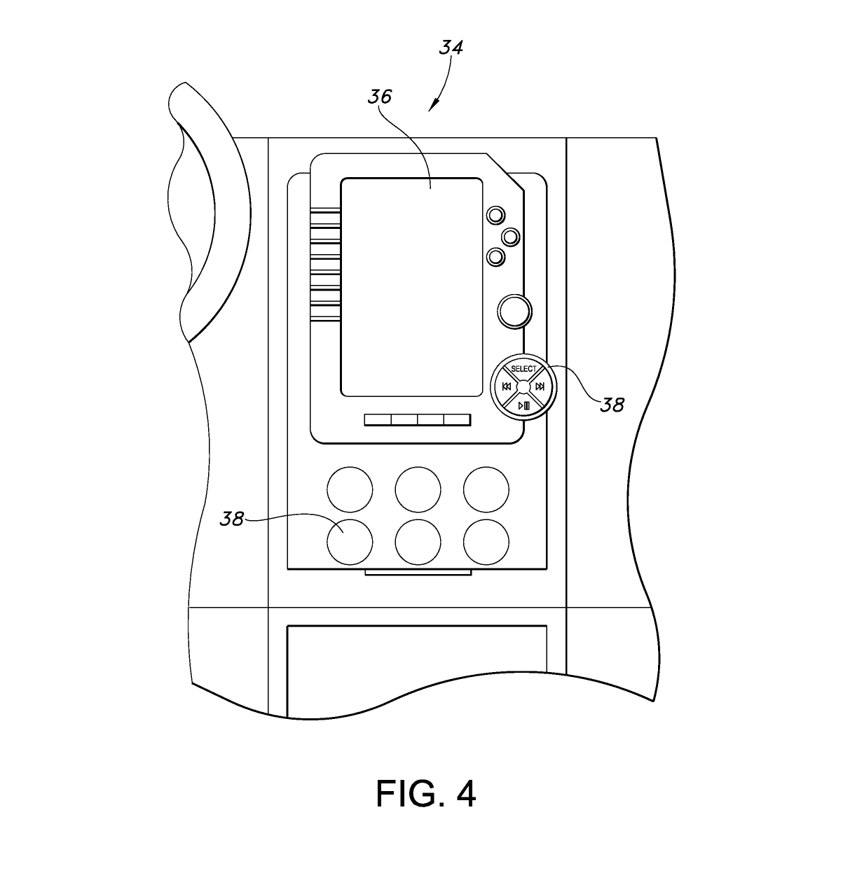

With further reference to FIG. 4, in order to create an alternative or additional verification capability, the user may have to input a code such as a PIN number or password before a transaction can be completed. In order to facilitate the input of such information, the payment apparatus 26 may further include a user interface device 34 operably connected to the payment apparatus CPU 20. The user interface device 34 may include a display 36 and user input devices 38 such as buttons or key pad. The display 36 and user input devices 38 may be integrated in the form of a touch screen monitor. The user interface device 34 may be configured to permit a user to input a password and or select services and make purchases. For example, the user may view and download content such as GPS services, music, etc. The user interface device 34 may allow a user to view prior transactions and other account information.

After such payment transactions are made by the user, the payment apparatus 26 can store in memory and track all payment transactions conducted using the payment device 14. This saved information can then be subsequently downloaded and reviewed. One way to view the information would be on the interface device display 36. Alternatively, the payment apparatus may include a communication port of a type known in the art that could interface with a remote commuting device. This could be achieved via a wired or wireless connection. In this way, an owner of the vehicle or the party responsible for making the payments could monitor the transactions to ensure that the payment device 14 is being used appropriately.

The CPU 20 may be configured to save data in predetermined or user created categories. One category may be a vehicle history category under which information such as scheduled maintenance payments, repair payments, gas payments or other payments directly related to the vehicle is saved. Another category may be an owner specific category which stores information for such payments as downloadable content, food, or other purchases of goods. If a vehicle is sold, the data saved under vehicle history category may remain with the vehicle and be accessed by the new owner. However, the data saved under the owner specific category may be deleted. It is within the contemplation of the present invention that numerous other data categories and subcategories may be saved, certain of which may be designated to survive a transfer to a new owner and others designated to be deleted prior to transfer.

In an alternative embodiment (not shown), the communicating device may be removably attachable to the vehicle. This may be in the form of a RFID device which a user may use to make payments. This may be used for tap and go, near field and m-commerce transactions associated with the vehicle. In each of these transactions, the unique account number would be the vehicle identification number.

It is desirable to restrict the use of the payment device based on the vehicle operator and/or the type of transaction. Different operators of the vehicle 10 could have different payment permissions. In one embodiment, each operator may be given a unique vehicle key including a chip that includes a code specific to that operator. Alternatively, a user may need to input a user specific code. This way the payment apparatus may only activate the transmission of the VIN under certain user-specific predetermined conditions. For example, a particular operator may not have authority to pay for downloadable content. In order to limit the types of transactions, the CPU 20 could be programmed to restrict the transmission of the VIN to prevent certain types of purchase. For example, purchases of gas may be permitted but sales for food or other goods may be restricted. In this way, the owner of the vehicle, or the person responsible for the financial account, can limit the use of the VIN for payment transactions.

A typical operation of the present invention will now be described. An individual may purchase a vehicle 10 having a payment apparatus installed therein 26. Upon purchasing the vehicle, the new owner may be offered the option of activating the vehicle as a payment device. Activation includes associating the VIN with a particular financial account. This account may be a bank account in which the vehicle would act like a debit card in which financial transactions withdraw money directly from a bank account. Alternatively, the account may be in the form of a credit card wherein the payment transactions are itemized and a bill is sent to the owner periodically for payment. The offer to activate the payment device may be made by a financial institution such as a bank in association with a payment facilitating network such as the MasterCard network. Once the account is established and set up, the user may start using the VIN to conduct payment transactions. The financial account number may be based upon the VIN and include the VIN or a portion thereof.

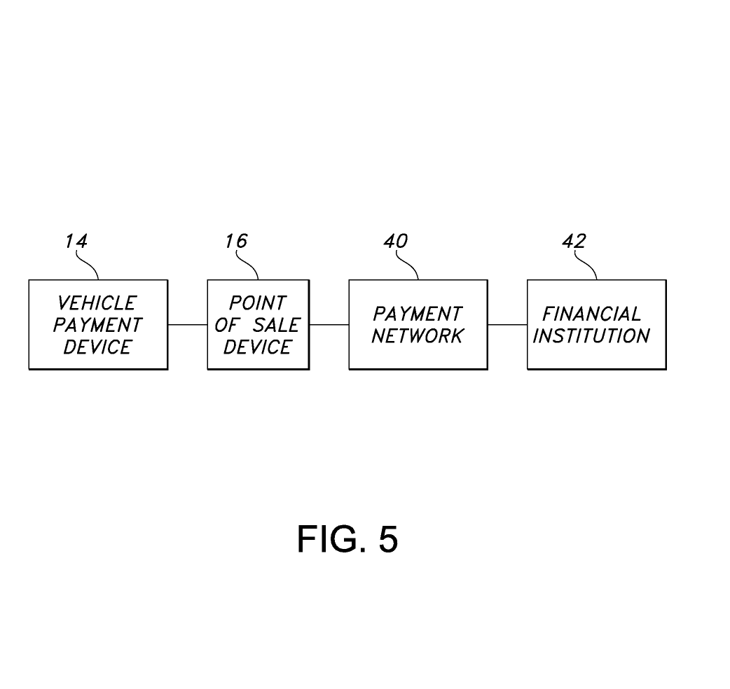

With reference to FIGS. 3 and 5, in order to conduct a payment transaction using the VIN, the verification element 30 determines if a verification condition has been met. In the embodiment requiring the present of the key 32, the verification element senses the presence of the key and communicates a signal to the CPU 20 reflecting this condition. The CPU 20 may then cause the communicating device 18 to emit a signal corresponding to the VIN to a point of sale device 16. The point of sale device 16 is in operative communication with a payment network 40. The payment network is in operative communication with a financial institution 42 which makes the payment to the merchant. Accordingly, the VIN is used to conduct the payment transaction in a manner similar to the use of a PAN on a card-type payment device. The VIN may be processed over an existing payment network which pays the merchant and debits the user's account.

In the event that a vehicle is sold, the account could be terminated for the previous owner and a new account could be established for the new owner based on the VIN. Any transactions occurring after the transfer of ownership would be credited to the new owner.

Since the payment device 14 is inherent with the vehicle, an operator would never need an additional card or device in order to make a payment transaction. As long as the operator has the vehicle and keys in which to activate the payment apparatus, payment transactions can be made. Furthermore, the issuing entity such as a bank has a device which is durable and lasts as long as the car thereby obviating the need to periodically generate new payment devices as in the case with traditional credit cards or payment tags.

While the embodiment of the vehicle shown herein is in the form of an automobile, it is within the contemplation of the present invention that the vehicle could be any such vehicle which is manufactured with or assigned a unique identification number.

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made expressly herein, without departing from the spirit and scope of the invention.

What is claimed is:

1. A payment device comprising:
a vehicle having a unique identifier associated therewith, the unique identifier being associated with and identifying a specific financial payment account to permit a payment transaction for the purchase of goods and/or services.

2. The payment device as defined in claim 1, wherein the unique identifier is the Vehicle Identification Number (“VIN”).

3. The payment device as defined in claim 2, wherein financial payment account number is based upon the VIN.

4. The payment device as defined in claim 2, wherein the financial payment account number includes at least a portion of the unique identifier.

5. The payment device as defined in claim 2, wherein the vehicle includes a transmitting device for selectively transmitting the VIN.

6. The payment device as defined in claim 5, wherein the transmission of the VIN requires the presence of a verification element.

7. The payment device as defined in claim 6, wherein the verification element includes a vehicle key.

8. The payment device as defined in claim 6, wherein the verification element includes the entry of a code.

9. The payment device as defined in claim 1, wherein the financial account is one of a bank deposit account, a credit card account, and pre-pay account.

10. The payment device as defined in claim 5, wherein the transmitting device includes a RFID device.

11. The payment device as defined in claim 1, wherein the vehicle includes a payment apparatus including a processor and a communicating device operably connected thereto, the processor controlling the operation of communicating device.

12. The payment device as defined in claim 11, wherein the payment apparatus includes a memory device for recording payment transactions.

13. The payment device as defined in claim 11, wherein the payment apparatus includes a user interface.

14. The payment device as defined in claim 13, wherein the user interface includes a display and a selection element to permit a user to initiate a payment transaction.

15. The payment device as defined in claim 1, wherein the communicating device is removably secured to the vehicle, the communicating device emitting a signal including the VIN to facilitate a payment transaction when removed from the vehicle.

16. A system for conducting a payment transaction comprising:
a vehicle having a Vehicle Identification Number (“VIN”) associated therewith, the VIN forming at least part of a financial payment account number to permit a payment transaction based upon the VIN; and
a payment apparatus disposed within the vehicle, the payment apparatus including a communicating device for selectively transmitting the VIN, the communicating device being in operative communication with a point of sale device to permit transmission of the VIN to the point of sale device, wherein transmission of the VIN in the point of sale device facilitates the payment transaction.

17. The system as defined in claim 16, wherein the payment apparatus includes a user interface to permit a user to control the payment transition.

18. The system as defined in claim 16, further including a verification element, the verification element being responsive to a verification condition, wherein the transmission of the VIN requires the verification condition to be met.

19. The system as defined in claim 18, wherein the verification condition includes the presence of the key in or adjacent to the vehicle.

20. The system as defined in claim 16, wherein the verification condition includes the communication of a code to the payment apparatus.

21. The system as defined in claim B, wherein the payment account number corresponds to the VIN.

22. The system as defined in claim 16, wherein the communicating device is fixed to the vehicle.

23. The system as defined in claim 16, wherein the communicating device is removable from the vehicle.

24. A method of establishing functionality of a payment device comprising:
obtaining a vehicle specific vehicle identification number (“VIN”);
associating the VIN with a particular financial payment account;
storing the association on a payment network; and
selectively facilitating payment transactions based on the VIN.

25. A method of conducting a payment transaction comprising:
providing a vehicle having a unique vehicle identifier associated therewith, the unique identifier being associated with and identifying a specific financial payment account to permit a payment transaction for the purchase of goods and/or services; and
communicating a signal including a unique vehicle identifier to a point of sale device.

26. The method as defined in claim 25, further including verification of the transaction.

27. The method as defined in claim 26, wherein verification includes transporting a key into the vehicle or adjacent the vehicle.

28. The method as defined in claim 26, wherein verification includes entering a code prior to communication of the unique identifier.

29. The method as defined in claim 25, wherein the unique identifier is the Vehicle Identification Number (“VIN”).
